(19) United States
(12) Patent Application Publication
(10) Pub. No.: US 2013/0290133 A1
(43) Pub. Date: Oct. 31, 2013

(54) METHODS AND SYSTEMS FOR ONLINE COMMERCE

(71) Applicant: ZMAGS CORP., Boston, MA (US)

(72) Inventor: Michael Schreck, Dover, MA (US)

(73) Assignee: Zmags Corp., Boston, MA (US)

(21) Appl. No.: 13/870,415

(22) Filed: Apr. 25, 2013

Related U.S. Application Data
(60) Provisional application No. 61/637,936, filed on Apr. 25, 2012.

(51) Int. Cl. G06Q 30/06

(52) U.S. Cl. CPC G06Q 30/0633
USPC 705/26.8

(57) ABSTRACT

Methods and systems for simplifying an online catalog shopping experience by enabling an online shopper to add multiple discrete products that are purposely or properly grouped for collective sale into an electronic shopping cart with a single action, e.g., clicking a mouse button.

### CROSS-REFERENCE TO RELATED APPLICATION

This application claims priority to and the benefit of U.S. Provisional Patent Application No. 61/637,936 filed on Apr. 25, 2012, which is incorporated in its entirety herein by reference.

### FIELD OF THE INVENTION

In various embodiments, the invention relates to electronic commerce, and more particularly, to methods and systems for simplifying and streamlining online shopping especially in the sale of products that are properly or purposely grouped for sale collectively as a group or outfit.

### BACKGROUND

Numerous online commerce sites provide the functionality of an electronic catalog of products that consists of multiple catalog pages offering one or more products for the online shopper to peruse. Typically, upon selecting a product of interest found on a first web page, shoppers are directed to a separate web page for viewing product details and, then, after adding that product to their electronic checkout or shopping cart, to another, separate web page, requiring shoppers to navigate away from the original web page to view product and purchase details. This can confuse many shoppers, some of whom may be unable to determine how to purchase the item(s) or how to continue shopping. Confusion may lead to frustration, causing some shoppers to leave the site altogether without making a purchase. For sellers, requiring shoppers to view multiple web pages to make a purchase lowers conversion rates, leading to less revenue and lower profits.

Another shortcoming of current electronic catalogs is that typically there is a one-to-one relationship between discrete products and the shopping process. More specifically, a shopper typically performs a number of clicking events, eventually resulting in the discrete product appearing in the user's electronic shopping cart. While this works well for single, discrete items that are meant to be sold as such, there is wasted time and inconvenience when shoppers must go through this procedure to purchase a group of discrete products that are properly or purposely combined or grouped for collective purchase as a group. Examples of products that may be grouped would include, for the purpose of illustration and not limitation, clothes, outfits, uniforms, cosmetics, beauty supplies, hair products, sporting goods, sports equipment, furniture, linen and bedding, and so forth.

Accordingly, there is a need for improved methods and systems that simplify an online shopping experience, especially in the sale of products that are properly or purposely grouped for sale as a group or outfit.

### SUMMARY OF THE INVENTION

Embodiments of the present invention streamline and simplify the online shopping experience by making it easier for shoppers to view product details and purchase items from an online catalog. In some embodiments, the systems and methods described herein allow a user to view product details in a product details window while the original page remains open and visible. The user may then add the product to an electronic shopping cart and subsequently return to the original page for further shopping, without ever navigating away from the original page. In general, the systems and methods lead to higher conversion rates, i.e., a higher likelihood that the user will purchase a product, and enable higher average order values due to the ease with which users can purchase multiple items, with fewer clicks and fewer web pages visited.

In one aspect, embodiments of the invention relate to a method of placing an order for a plurality of items that have been grouped for collective sale. The method includes displaying a webpage having an image(s) of a plurality of items grouped for collective sale, e.g., each of the multiple images corresponding to a unique item in the plurality of items grouped for collective sale; in response to a first user-generated action, presenting the plurality of items grouped for collective sale; and in response to a second user-generated action, e.g., by a single action, adding the plurality of items grouped for collective sale to an electronic shopping cart for purchase. Advantageously, when the plurality of items grouped for collective sale is presented and/or when adding the plurality of items grouped for collective sale to the electronic shopping cart, the plurality of items is presented in, e.g., an overlay or a lightbox, such that the original web page is partially obscured and interactions with the original web page are disabled.

In other aspects of the embodiment, the method further includes: in response to a third-user generated action, removing an item(s) from the presented plurality of items grouped for collective sale; in response to a fourth user-generated action, concatenating a size and/or a color preference to at least one of the plurality of items grouped for collective sale before adding the item to an electronic shopping cart; in response to a fifth user-generated action, substituting another product for one of the items in the plurality of items grouped for collective sale; displaying a cost for each of the plurality of items grouped for collective sale when presenting the plurality of items grouped for collective sale; and/or displaying individual images of each of the plurality of items grouped for collective sale.

In another embodiment of the present invention, an article of manufacture for ordering a plurality of items grouped for collective sale is disclosed. The article includes embedded computer-readable program portions that include instructions for: displaying an image(s) having a plurality of items grouped for collective sale; in response to a first user-generated action, presenting the plurality of items grouped for collective sale; and in response to a second user-generated action, e.g., a single action, adding the plurality of items grouped for collective sale to an electronic shopping cart for purchase. Advantageously, instructions for presenting the plurality of items grouped for collective sale and/or for adding the plurality of items grouped for collective sale to the electronic shopping cart, include instructions presenting the plurality of items in, e.g., an overlay or a lightbox, such that the original webpage is partially obscured and interactions with the original web page are disabled.

In other aspects of the embodiment, the program portions include further instructions for: in response to a third-user generated action, removing an item(s) from the presented plurality of items grouped for collective sale; in response to a fourth user-generated action, concatenating a size and/or a color preference to at least one of the plurality of items grouped for collective sale before adding the item to an electronic shopping cart; in response to a fifth user-generated action, substituting another product for one of the items in the plurality of items grouped for collective sale; displaying a cost for each of the plurality of items grouped for collective sale when presenting the plurality of items grouped for collective sale; and/or displaying individual images of each of the plurality of items grouped for collective sale.

In yet another embodiment, the present invention discloses a system for receiving an order for a plurality of items grouped for collective sale via a network. The system includes a server device that is adapted to transmit data for displaying a web page on a display device at a client device; to receive a user-generated selection of the plurality of items grouped for collective sale; to populate an electronic shopping cart with the plurality of items grouped for collective sale; and, furthermore, to depopulate an item(s) from the plurality of items grouped for collective sale from the electronic shopping bag.

These and other objects, along with advantages and features of embodiments of the present invention disclosed herein, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is an illustrative screenshot of a web page in an online catalog browsed by a user, in accordance with one or more embodiments of the present invention;

FIG. 2 is an illustrative screenshot of a product details window showing each of the grouped products that are displayed in the original web page, in accordance with one or more embodiments of the present invention;

FIG. 3 is an illustrative screenshot of an alternate product details window including individual costs of each discrete products, in accordance with one or more embodiments of the present invention;

FIG. 4 is a flowchart of a method of purchasing a product from an online catalog, in accordance with one or more embodiments of the present invention;

FIG. 5 shows an example of a computer system suited to provide one or more embodiments of the present invention; and

FIG. 6 illustrates an example of a distributed system including an online catalog system suited to provide one or more embodiments of the present invention.

### DETAILED DESCRIPTION OF THE INVENTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art while still remaining within the scope of the invention as described and as claimed.

Throughout the description, where apparatus and systems are described as having, including, and/or comprising specific elements and/or components, or where processes and methods are described as having, including, and/or comprising specific steps, it is contemplated that, additionally, there are apparatus and systems of the present invention that consist essentially of and/or consist of the recited components, and that there are processes and methods according to the present invention that consist essentially of and/or consist of the recited processing steps.

It should be understood that, absent words to the contrary, the order of steps or order for performing certain actions is immaterial so long as the invention remains operable. Moreover, two or more steps or actions can be conducted simultaneously.

In various embodiments, the methods and apparatus described herein allow an online shopper to browse a web page for products on an electronic commerce site, view details for the products, and add the products to an electronic shopping cart or bag, all without navigating away from the original web page. For example, when viewing the online catalog, the shopper may identify grouped products of interest and provide input, e.g., via a mouse click or by voice command, to view details for each of the grouped products. Upon receipt of the input, product details windows are displayed over the original web page that list details for each product in the group. This may include one or more images of each of the products in the product group. From the product details window, the user adds all or less than all of the product items to an electronic shopping cart or bag and/or proceeds to checkout without navigating away from the original web page. Preferably, the second user-generated action is a single action. In one embodiment, the original web page is displayed in the background, beneath the product details window as described in greater detail in U.S. patent application Ser. No. 13/796,332 filed on Mar. 12, 2013 and entitled “Method and Apparatus for Online Commerce,” which is incorporated by reference herein in its entirety.

In certain embodiments, the product details window is displayed as a “lightbox,” i.e., a modal dialog overlaying the original web page, requiring the user to interact with the dialog before returning to the original web page. For example, a user who is browsing a web page in an online catalog may select a link to purchase a group of products on that web page. Selection causes the product details window to be displayed in an overlay to the current web page, instead of loading a new web page. While the product details window is displayed, the underlying web page, i.e., the web original page in the online catalog, may be darkened and/or temporarily disabled to focus the user on the overlay as described in greater detail in U.S. patent application Ser. No. 13/796,332 filed on Mar. 12, 2013 and entitled “Method and Apparatus for Online Commerce,” which is incorporated by reference herein in its entirety. The product details window page may be animated and/or positioned and sized according to the user's browser window.

In some embodiments, the product details window includes a selector or link that allows the user to add all or less than all of the grouped products to the user's electronic shopping cart. To perform this task, the user's web browser may make a HTTP request using any data transfer across the HTTP protocol, e.g., AJAX, SOAP Web Services, a proprietary protocol, and the like, to an “add to cart” function of the web site, to add all or less than all of the grouped product to the user's shopping cart. The user may then be presented with the option to continue shopping using the online catalog or to proceed to checkout. If the user continues shopping, the product details window disappears and the user is automatically returned to the original, underlying online catalog web page as described in greater detail in U.S. patent application Ser. No. 13/796,332 filed on Mar. 12, 2013 and entitled “Method and Apparatus for Online Commerce,” which is incorporated by reference herein in its entirety.

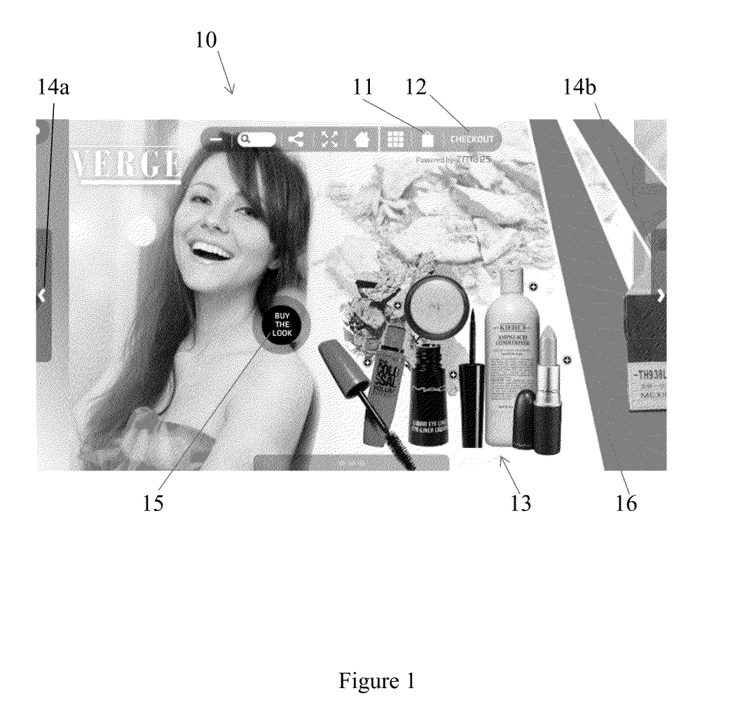

Referring to FIG. 1, in certain embodiments of the present invention, a user visits a web page 10 of an online catalog at which users may browse through different catalog pages as part of an inspirational shopping experience. Conventionally, the user may select a single product or item on the web page 10, e.g., by placing a cursor on the product or item, to obtain more information concerning the selected product or item. When a number of products or items are grouped together, this conventional procedure changes. Although the invention will be described assuming that the grouped products are cosmetic products, which are shown in the figures, this is done for illustrative purposes only and not for the purpose of limitation. Indeed, those of ordinary skill in the art can appreciate the application of the teachings herein to a myriad of grouped products.

The web page 10 in FIG. 1 can be displayed on a remote user interface and can include any or all of the following features: an image 16, which, preferably, includes images of grouped products or items 13, an electronic shopping cart or shopping bag selector or button 11, a checkout selector or button 12, selectors or buttons for “flipping” the web page 14a, 14b of the electronic online catalog, and a “BUY THE LOOK” selector or button 15, which will be described in greater detail below.

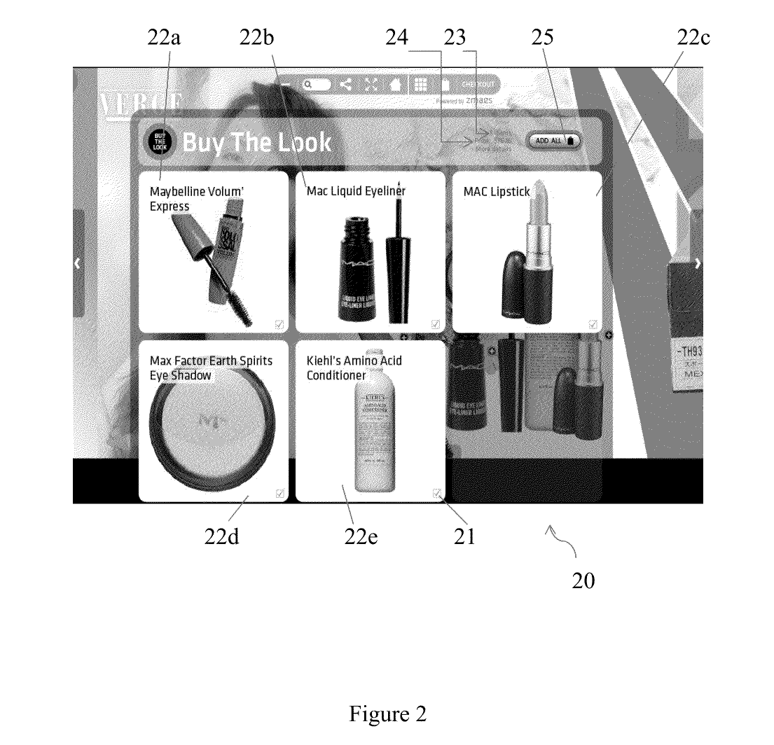

The “BUY THE LOOK” selector or button 15 requires a single shopper action to obtain more information about all of the products or items grouped for collective sale. For example, referring to FIG. 2, after a user has decided to “BUY THE LOOK,” e.g., by clicking on the “BUY THE LOOK” selector or button 15 or by voice command such as “BUY THE LOOK,” a product details window 20 is displayed. In the depicted embodiment, the product details window 20 is displayed as an overlay of or as a lightbox displayed on the original online catalog web page 10, which is darkened. If a user chooses to close the product details window 20, the user is automatically returned to the original web page 10, requiring no further action or input from the user.

The product details window 20 provides a description and displays an image 22a-22e of each of the products or items grouped in “THE LOOK”. Users who desire more information about any of the grouped products or items 13 can access product information, e.g., sizes, colors, cost, reviews, and the like, by clicking on the particular product or, alternatively, by voice command. The “BUY THE LOOK” feature is predicated on the notion that the user desires to purchase all of the grouped products or items 13; hence, there is no requirement for the user to input a quantity, which is assumed to be and pre-established to be one (1). A pre-checked box 21 associated with each of the product images 22a-22e indicates that presumption. Optionally, users may opt out of one or more of the grouped products or items 13 to buy less than all of “THE LOOK,” e.g., by clicking on the pre-checked box 21 to remove the check or by verbal command. Users may also include personal preferences in connection with the products or items, e.g., by inputting size and color preferences, which, again, can be performed by clicking on a color menu or a size menu associated with the particular product or item among the grouped products or items. Alternatively, color and size selections can be made by voice command.

Additional features of the product details window 20 can include a number of items display 23, a total cost display 24, and an “ADD ALL” button 25. The number of items display 23 shows the number of grouped products or items 13 for collective sale that are checked. The number will equal the mathematical difference between the number of grouped products or items 13 less the number of products or items that the user has opted out of purchasing. The total cost display 24 provides a total cost of the products or items that equals the mathematical difference between the cost of the grouped products or items 13 less the cost of any product or item that the user has opted out of purchasing. By selecting the “ADD ALL” button 25, all of the grouped products or items 13 less any of those that the user has opted out of, i.e., that remain checked, are automatically added as a group to the user's shopping cart or bag for a collective sale. Advantageously, the addition of plural, grouped products or items occurs with a single action rather than requiring the user to select each of the grouped products or items for inclusion individually. With the present invention, only those grouped products or items that a user does not want require further action on the user's part.

Once the user chooses to add all or less than all of the grouped products or items 13 to their shopping cart or bag, a HTTP request using any data transfer across the HTTP protocol, e.g., AJAX, SOAP Web Services, a proprietary protocol, and the like, is made to the web site's “add to cart” URL. The call may include configurable variables to effectively present the same call that would otherwise be made on a separate product details page of the e-commerce engine. Once the grouped products or items 13 are collectively added to the shopping cart or bag, a confirmation message can be displayed at the user interface in a manner that is well known to the art. For example, the confirmation message can be provided in a confirmation window or lightbox, with the original web page 10 still darkened and displayed in the background. The confirmation window gives the user the option to continue shopping or to proceed to the shopping cart or checkout page. If the user elects to continue shopping, the confirmation window disappears and the underlying original web page 10 is automatically reactivated.

In certain embodiments, once the user elects to proceed to checkout, the user is automatically directed to a checkout page (not shown) for the e-commerce engine. In this instance, the user may be navigated away from the original web page 10, such that the underlying catalog web page 10 is no longer displayed or is displayed as a darkened background. The checkout page may therefore represent the first time since the beginning of the shopping experience that the original electronic catalog web page 10 is no longer displayed at the user interface.

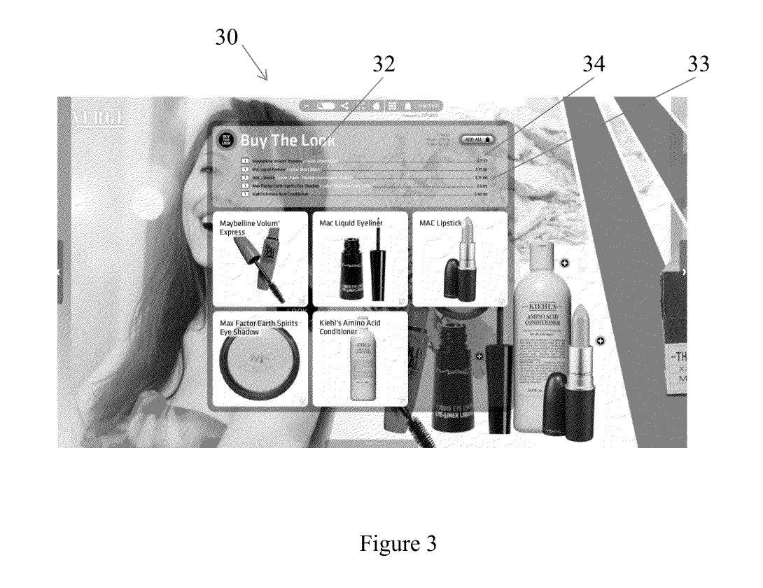

FIG. 3 shows an alternative embodiment of a product details window 30. The alternative product details window 30 includes all of the features of the previously described product details window 20 in FIG. 2, further including, for example, a list 32 of each grouped product or item 13, the individual price 34 of each grouped product or item 13, size and color options (not shown), and a pre-checked box 33, which, as with FIG. 2, is provided as a fast and convenient means to opt out of the purchase of one or more of the grouped products or items 13.

Although not shown in connection with the illustrative cosmetics example, users would be able to input sizes, colors, and other personal choices for apparel, shoes, hats, and so forth, e.g., by clicking on a size menu, a color menu, and so forth. Optionally, if any user feels that the cost of one or more of the grouped products or items 13 is too high, the user would be able to search for less-expensive generic substitutes or for substitute items that are on sale or marked for clearance. Consequently, users would still be able to “BUY THE LOOK” but would do so using generic cosmetics rather than name brand products or items. Those of ordinary skill in the art can appreciate that substitute and clearance products or items can be displayed using a link (not shown) that takes the user from the images 22a-22e of the grouped products or items 13 in the product details window 20, 30 to a generic substitute web page(s) and/or to a sale/clearance web page(s) for similar or like items.

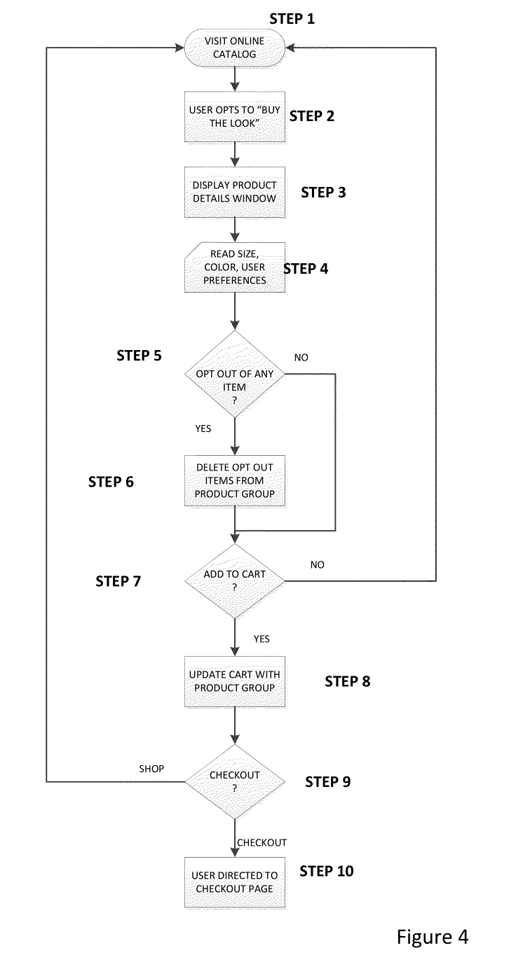

FIG. 4 is a flowchart showing methods of simplifying and enhancing online shopping, in accordance with certain embodiments of the present invention. The method begins when a user visits an online catalog web site (STEP 1). While browsing products in the electronic catalog, the user may select or click on a “BUY THE LOOK” selector or button (STEP 2) associated with a product group comprising a plurality of products or items purposely or properly grouped for collective sale. A product details window is displayed at the user's interface (STEP 3). As described in greater detail above, the product details window includes images of each of the products or items comprising the product group and can be presented as an overlay or lightbox on the original webpage presenting the products grouped for sale.

By interacting with any of these images, the user can obtain more information about each grouped product or item. The user then has the option of selecting sizes, colors and making any other personal choices as to the particular products or items (STEP 4). Moreover, the user may opt out (STEP 5) of the purchase of one or more of the products or items in the product group. If the user decides to opt out (STEP 5), that product(s) or item(s) is deleted from the product group for that discrete user (STEP 6).

The user is then queried whether or not to add the grouped products to the user's shopping cart or bag (STEP 7). If the user decides not to add the grouped products to the user's shopping cart or bag, the product details window overlay/lightbox is closed and the user is returned to the original product web page (STEP 1). Alternatively, if the user chooses to add all or less than all of the grouped products to the user's shopping cart or bag, then the user's shopping cart or bag is updated with all or less than all of the products or items in the product group (STEP 8) and the user is provided with confirmation, e.g., displayed in a confirmation window, that the grouped products as a whole or as modified by the user have been successfully added to the user's shopping cart or bag (STEP 8). Advantageously, choosing to add all or less than all of the grouped products or items to the user's shopping cart or bag requires a single action by the user, e.g., by clicking the “ADD ALL” selector or button or by verbal command to “ADD ALL,” to populate the user's shopping cart or bag with the products or items in the product group.

At this point, once the products or items from the product group have been added to the user's shopping cart or bag, the user may continue to shop or proceed to checkout (STEP 9). If the user chooses to continue shopping, the user is returned to the original product web page of the online catalog (STEP 1). Alternatively, if the user chooses to proceed to checkout, the user is directed to a checkout page (STEP 10) and the sale is transacted in a manner that is well known to the art.

### Computer System

Various aspects and functions described herein in accord with the present invention may be implemented as hardware or software on one or more computer systems. There are many examples of computer systems currently in use including network appliances, personal computers, workstations, mainframes, networked clients, servers, media servers, application servers, database servers, and web servers. Other examples of computer systems may include mobile computing devices, such as cellular phones, personal digital assistants, and network equipment, such as load balancers, routers, and switches. Furthermore, aspects in accord with the present invention may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Moreover, aspects may be implemented in software, hardware or firmware, or any combination thereof. Thus, aspects in accord with the present invention may be implemented within methods, acts, systems, system elements, and components using a variety of hardware and software configurations, and the invention is not limited to any particular distributed architecture, network, or communication protocol.

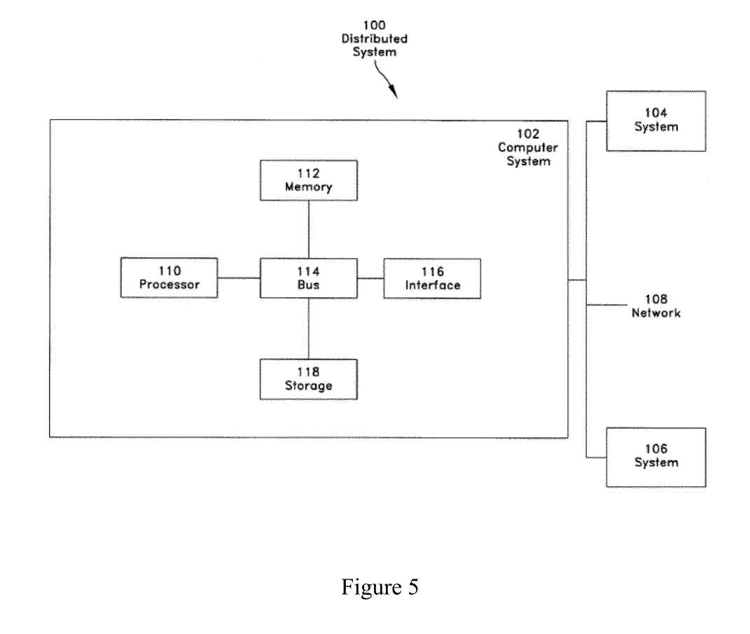

FIG. 5 shows a block diagram of a distributed computer system 100, in which various aspects and functions in accord with the present invention may be practiced. Distributed computer system 100 may include one or more computer systems 102, 104, and 106. Although only three computer systems 102, 104, and 106 are shown in FIG. 5, this is done for the purpose of illustration and not limitation. Computer systems 102, 104 and 106 are interconnected by, and are adapted to exchange data through, a communication network 108. Network 108 can include any communication network through which computer systems 102, 104, and 106 can exchange data. To exchange data using network 108, computer systems 102, 104, and 106 and network 108 may use various methods, protocols, and standards, including, inter alia, token ring, Ethernet, TCP/IP, UDP, HTTP, FTP, and SNMP. To ensure data transfer is secure, computer systems 102, 104, and 106 may transmit data via network 108 using a variety of security measures including TLS, SSL, and/or other security techniques.

Various aspects and functions in accordance with the present invention may be implemented as specialized hardware or software executing in one or more computer systems including computer system 102 shown in FIG. 5. Computer system 102 includes a processing device (“processor”) 110, a first data storage device(s) (“memory”) 112, an interface 116, and a second data storage device(s) (“storage”) 118. The processor 110 and the other elements are interconnected electrically and electronically via a bus 114. The processor 110 may be a commercially available processor such as an Intel Core, Motorola PowerPC, MIPS, UltraSPARC, or Hewlett-Packard PA-RISC processor, but may be any type of processor or controller as many other processors and controllers are available. The processor 110 is structured and arranged to perform a series of instructions, e.g., an application, an algorithm, a driver program, and the like, that result in manipulated data.

Memory 112 may be used for storing programs and data during operation of computer system 102. Thus, memory 112 may be a relatively high performance, volatile, random access memory such as a dynamic random access memory (DRAM) or static memory (SRAM). However, memory 112 may include any device for storing data, such as a disk drive or other non-volatile storage device. Various embodiments in accord with the present invention may organize memory 112 into particularized and, in some cases, unique structures to perform the aspects and functions disclosed herein.

Components of the computer system 102 may be coupled by an interconnection element such as a bus 114. The bus 114 may include one or more physical busses (for example, between components that are integrated within a same machine), but may include any communication coupling between system elements including specialized or standard computing bus technologies such as IDE, SCSI, PCI, and InfiniBand. Thus, the bus 114 enables communications, e.g., the transfer of data and instructions, to be exchanged between components of the computer system 102.

Computer system 102 also includes one or more interface devices 116 such as input devices, output devices, and combined input/output devices. Interface devices allow computer system 102 to exchange information and communicate with external entities, such as users and other systems. Interface devices 116 are adapted to receive input or to provide output. More particularly, output devices may render information for external presentation, for example, on display devices. Input devices may accept information from external sources. Examples of interface devices include keyboards, mouse devices, trackballs, microphones, touch screens, printing devices, display screens, speakers, network interface cards, and so forth.

The second data storage device 118 may include a computer readable and writeable nonvolatile storage medium in which instructions are stored that define a program, application, algorithm, and the like to be executed by the processor 110. Storage system 118 also may include information that is recorded, on or in, the medium, and this information may be processed by the program, application, algorithm, and the like. More specifically, the information may be stored in one or more data structures specifically configured to conserve storage space and/or to increase data exchange performance. The instructions may be persistently stored as encoded signals, and the instructions may cause a processor 110 to perform any of the functions described herein. The data storage medium may, for example, be optical disk, magnetic disk or flash memory, among others.

In operation, the processor 110 or some other controller may cause data to be read from the nonvolatile recording medium, i.e., the second data storage device 118, into another data storage device, such as memory 112, to allow for faster access to the information by the processor 110 than does the storage medium included in storage system 118. Such data storage may be located in the second data storage device 118 and/or in memory 112. The processor 110 also may manipulate the data within the memory 112, and then copy the data to the medium associated with the second data storage device 118 after processing is completed. A variety of components may manage data movement between the medium and integrated circuit memory element and the invention is not limited thereto. Further, the invention is not limited to a particular memory system or storage system.

Although the computer system 102 is shown by way of example as one type of computer system upon which various aspects and functions in accord with the present invention may be practiced, aspects of the invention are not limited to being implemented on the computer system 102 as shown in FIG. 5. Various aspects and functions in accord with the present invention may be practiced on one or more computers having different architectures or components than those shown in FIG. 5. For instance, computer system 102 may include specially-programmed, special-purpose hardware, such as for example, an application-specific integrated circuit (ASIC) tailored to perform a particular operation disclosed herein. While another embodiment may perform the same function using several general-purpose computing devices running MAC OS System X with Motorola PowerPC processors and several specialized computing devices running proprietary hardware and operating systems.

The computer system 102 may be a computer system including an operating system that manages at least a portion of the hardware elements included in the computer system 102. Usually, a processor or controller, such as processor 110, executes an operating system which may be, for example: a Windows-based operating system, e.g., Windows 7, Windows 2000 (Windows ME), Windows XP operating systems, and the like, available from the Microsoft Corporation, a MAC OS System X operating system available from Apple Computer, one of many Linux-based operating system distributions, e.g., the Enterprise Linux operating system, available from Red Hat Inc., or a UNIX operating system available from various sources. Many other operating systems may be used, and embodiments are not limited to any particular implementation.

The processor and operating system together define a computer platform for which application programs in high-level programming languages may be written. These component applications may be executable, intermediate, e.g., C−, or interpreted code which communicate over a communication network, e.g., the Internet, using a communication protocol, e.g., TCP/IP. Similarly, aspects in accordance with the present invention may be implemented using an object-oriented programming language, such as SmallTalk, Java, C++, Ada, or C# (C-Sharp). Other object-oriented programming languages may also be used. Alternatively, functional, scripting, or logical programming languages may be used.

Additionally, various aspects and functions in accord with the present invention may be implemented in a non-programmed environment, e.g., documents created in HTML, XML or other format that, when viewed in a window of a browser program, render aspects of a graphical-user interface or perform other functions. Furthermore, various embodiments in accordance with the present invention may be implemented as programmed or non-programmed elements, or as any combination thereof. For example, a web page may be implemented using HTML while a data object called from within the web page may be written in C++. Thus, the invention is not limited to a specific programming language. Indeed, any suitable programming language could be used.

A computer system included within an embodiment may perform functions outside the scope of the invention. For instance, aspects of the system may be implemented using an existing commercial product, such as, for example, Database Management Systems such as SQL Server available from Microsoft of Seattle, Wash., Oracle Database from Oracle of Redwood Shores, Calif., and MySQL from MySQL AB of Uppsala, Sweden or integration software such as Web Sphere middleware from IBM of Armonk, N.Y. However, a computer system running, for example, SQL Server may be able to support both aspects in accordance with the present invention and databases for sundry applications not within the scope of the invention.

### Illustrative System Architecture

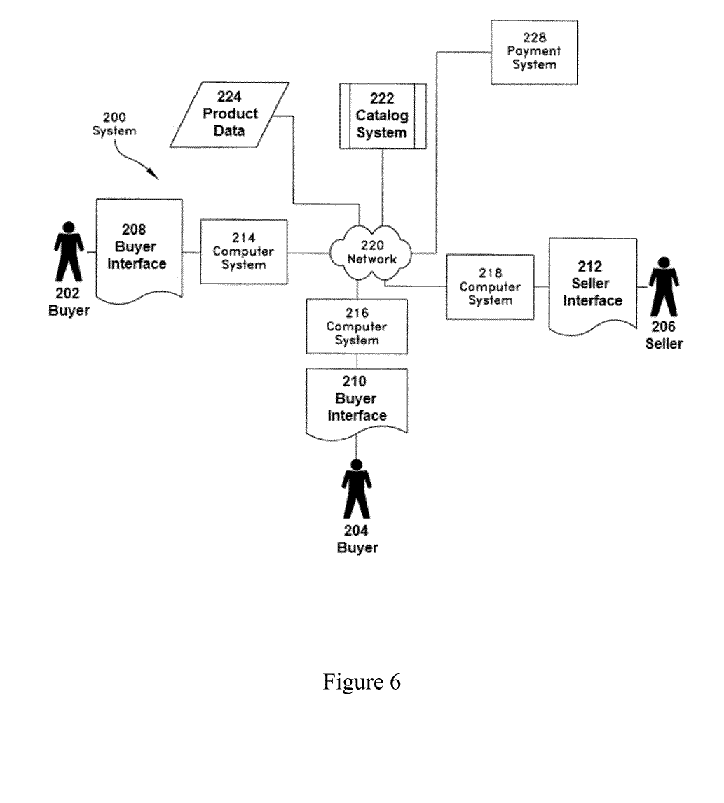

FIG. 6 presents a context diagram of a distributed system 200 configured to provide an online catalog platform in accordance with the present invention. Referring to FIG. 6, system 200 may include buyers 202 and 204, a seller 206, buyer interfaces 208 and 210, a seller interface 212, computer systems 214, 216, and 218, a communications network 220, a catalog system 222, product data 224, and a payment system 228. The system 200 may allow buyers 202 and 204 to interact with buyer interfaces 208 and 210, respectively. Similarly, the system 200 may allow a seller 206 to interact with a seller interface 212. The system 200 may also cause a catalog system 222 to interact with a payment system 228 and receive product data 224.

According to the depicted embodiment, interfaces 208, 210, and 212 may be browser-based user interfaces served by a catalog system 222 and may be rendered by computer systems 214, 216, and 218. Computer systems 214, 216, and 218 may be interconnected with one another and the catalog system 222 via a network 220. The network 220 may include any communication network through which member computer systems may exchange data, e.g., the World, Wide Web, the Internet, an intranet, a wide area network (WAN), a local area network (LAN), and so forth.

The sundry computer systems shown in FIG. 6, which include computer systems 214, 216, and 218, the network 220, the catalog system 222, and the payment system 228, each may include one or more computer systems. As discussed above with regard to FIG. 5, computer systems may have one or more processors or controllers, memory and interface devices. The particular configuration of the system 200 depicted in FIG. 6 is used for illustration purposes only and embodiments of the invention may be practiced in other contexts. Thus, the invention is not limited to a specific number of users or systems.

The catalog system 222 is adapted to manage transactions between one or more sellers and one or more buyers, such as seller 206 and buyers 202 and 204. In the illustrated embodiment, the catalog system 222 may provide buyer interfaces 208 and 210 to buyers 202 and 204, respectively, and a seller interface 212 to a seller 206. Interfaces 208, 210, and 212 may be presented to users 202, 204, and 206 via a network 220 on computer systems 214, 216, and 218, respectively. As discussed herein, the catalog system 222 is adapted to enable buyers 202 and 204 to view product details and to add all or less than all of the products purposely concatenated in a product group to electronic shopping carts as a group, without having to add each product in the product group to the shopping cart individually.

In various embodiments, the catalog system 222 may receive product data 224 from a variety of sources and may use it in transactions involving the buyers 202 and 204 and the seller 206. Product data 224 may include any current or past data related to items that are presented in the online catalog. Examples of product data 224 include, among other data, price data, product features, product descriptions, e.g., sizes, weights, and colors, images, product reviews, related products, product availability, seller information, and shipping information, e.g., shipping options, available discounts, and the like.

In other embodiments, the catalog system 222 may exchange data with payment system 228 to clear and settle transactions between buyers 202 and 204 and the seller 206. This data exchange may include requests for payment from the buyers 202 and 204. These requests for payment may result in funds transferred from the buyers 202 and 204 to the seller 206.

According to another embodiment, a third party, such as a financial institution or system service provider, acts as a financial intermediary between buyers and sellers. In this embodiment, the catalog system 222 may request that the payment system 228 transfer funds from the buyer to the financial intermediary. The financial intermediary may then transfer the funds from this and other buyers to the seller in a single transaction or a series of transactions. In this way, the anonymity of the buyers can be preserved, i.e., the seller may not know the identity of a particular buyer.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

What is claimed is:

1. A method of placing an order for a plurality of items from an electronic catalog, the method comprising:
displaying a web page having at least one image of a plurality of items grouped for collective sale;
in response to a first user-generated action, presenting the plurality of items grouped for collective sale; and
in response to a second user-generated action, adding the plurality of items grouped for collective sale to an electronic shopping cart for purchase.

2. The method as recited in claim 1, wherein at least one of presenting the plurality of items grouped for collective sale and adding the plurality of items grouped for collective sale to an electronic shopping cart includes partially obscuring the web page and disabling interactions with the web page.

3. The method as recited in claim 1, wherein the second user-generated action is a single action.

4. The method as recited in claim 1, wherein presenting the plurality of items grouped for collective sale includes displaying a cost for each of the plurality of items grouped for collective sale.

5. The method as recited in claim 1, wherein the at least one image includes multiple images, each of the multiple images corresponding to a unique item in the plurality of items grouped for collective sale.

6. The method as recited in claim 1 further comprising displaying individual images of each of the plurality of items grouped for collective sale.

7. A system for receiving an order for a plurality of items grouped for collective sale via a network, the system comprising:
a server device that is adapted:
to transmit data for displaying a web page on a display device at a client device;
to receive a user-generated selection of the plurality of items group for collective sale; and
to populate an electronic shopping cart with the plurality of items grouped for collective sale.
